(19) United States
(12) Patent Application Publication
(10) Pub. No.: US 2004/0216356 A1
(43) Pub. Date: Nov. 4, 2004

(54) Fly-type fishing lure

(76) Inventor: Walter R. Matchinga, Hudson, OH (US)

Correspondence Address: Fay, Sharpe, Fagan,, Minnich & McKee, LLP, 7th Floor, 1100 Superior Avenue, Cleveland, OH, 44114-2579, US

(21) Appl. No.: 10/409,501

(22) Filed: Apr. 8, 2003

(51) Int. Cl. A01K 85/00

(52) U.S. Cl. 43/42

(57) ABSTRACT

A fishing lure is disclosed which includes a body portion and a fish hook associated with the body portion. The fishing lure further includes an absorbent interior portion and an attachment line passing through the interior portion. The body portion comprises a soft plastic resin and the interior portion comprises a porous material. Preferably the porous material is impregnated with a fish scent attractant. The interior portion, and a segment of the attachment line proximal to the interior portion, is encapsulated by the body portion. Multiple body portions may be included in various forms and connected by the attachment line. A securing means is provided for attaching the attachment line and body portions to the fish hook.

### BACKGROUND OF THE INVENTION

This invention relates to an artificial fishing lure and, in particular, to a fishing lure having an odor attractant, which is designed for use in fly fishing or other light tackle fishing methods. Fishing lures have been used in a myriad of shapes and forms. Generally, the objective is to provide a lure that will attract fish and, for this purpose, various lures have been devised which, for example, provide visible indications such as light reflective surfaces, swimming motions, sound emitting sources, etc.

An artificial lure is to be contrasted with “live” bait. Live bait methods typically involve the use of live, near dead, or dead food sources that are the natural food sources of the fish species being sought. Naturally occurring food sources commonly used as bait include minnows, worms, maggots, spawn eggs, etc. Commonly, lures are provided which visually resemble and mimic the naturally occurring bait (e.g. minnows, worms, maggots, spawn eggs, etc.). In the field of fresh water fly-fishing, the historical objective for the artificial lure was only to mimic the shape and form of insects in various phases of development. The most successful fly fishing methods involve creating imitations of flies (i.e. artificial lures) which imitate a natural food source to the respective fish species. In most situations, the imitations are constructed such that their size, color, silhouette, and mode of traversing the water most closely matches a natural food source. In fly fishing, the mimicking of the natural motion of insects or other food sources involves recreating the crawling motion of nymphs, the swimming motion of emergers, the floating motion of adult insects, and/or a drifting motion of an insect within the current. The success of the aforementioned presentations rely on the fish species' visual sense. In more recent times, lures imitating individual or clusters of fish eggs or spawn have been utilized.

Attempts have been made to provide a method for attracting fish using an odor attractant. Difficulties arise with regard to a fishing lure that uses an odor attractant due to the way most lures are generally used. The general use typically involves trolling or a trolling-like method which places the lure in constant movement through the water. In these situations, if the odor attractant is not dispensed into the water, its effectiveness is limited because the lure can only emit an odor immediately surrounding the lure. If the odor is dispensed, it remains at the location where it was dispensed, and the lure will be moved away from the odor attractant during trolling. Another difficulty with an odoriferous fishing lure is constructing a lure whose effectiveness is not diminished with time while being stored in a tackle box or fishing vest. Currently, scented lures which are impregnated with fish attractant present an oily or slippery surface area. The storage and use of these lures contaminates storage containers, clothing, hands, and neighboring lures (flies).

In an alternate method, some products provide for the fish odor attractant to be applied directly to the exterior of the lure or embedded in an emulsifier forming a surface active plastic. However, once the lure contacts the water, the fish attractant is usually quickly dispersed, thereby necessitating frequent reapplication of the fish attractant to the lure. Because the fish attractant must be frequently reapplied to the lure, or because the plastic-forming mixture dissolves, prolonged use of the lure in the water is not possible.

Success in fly fishing often depends on water conditions. The use of an attractant odor is not always necessary and depends on water clarity. When the stream or river water is clear, salmonids (including salmon and trout) can and will locate prey by sight. When the water is cloudy or stained in color, smell facilitates or enables a salmonid to locate prey. There is a need for a lure which will dispense an odor attractant only when the fisherman chooses, whereby as the lure moves through the water, there is a preceding or concurrent emission of the odor attractant which will attract and lead fish to the lure. It has been demonstrated that the ability of certain fish species to smell their surroundings is nothing short of astounding. For example, one study shows that salmonids can detect dissolved substances in concentrations as low as one part in three quintillion (1 in 3,000,000,000,000,000,000). Trout Biology, An Angler's Guide. W. B. Willers. The University of Wisconsin Press, 1981.

Another challenge that arises occurs when the fish bites or “takes” the artificial lure. Typically in fly fishing, a salmonid or other species will often, after biting, reject a fly that is constructed of artificial materials which are rigid or stiff. The angler must set the hook by exerting enough tension on the line in order to move the artificial fly with the associated hook into the trout's jaw before the fish has had an opportunity to reject the fly. Thus, there is a need for an artificial fly which will attract fish by visual and olfactory senses while at the same time, provide a delayed rejection of the artificial fly upon the fish taking the fly. The delayed rejection will result from an artificial fly which mimics a natural food source in texture and taste.

Trout, salmon, and other fish in the family group of salmonid, are highly accustomed to eating natural fish eggs which are present in their natural habitat, such as streams and lakes. Salmonids are highly attracted to such eggs which provide a high protein food source, both when they are young, and when they return to their home streams after reaching maturity where they ascend to spawn. Typically, natural eggs that have been expelled by a female salmonid are deposited between and along the rocks at the river's bottom. Through the natural flow of the current of the water and other debris floating therein, eggs become dislodged from this deposit and drift with the current below the surface of the water. These dislodged eggs, along with the original deposits of eggs, become a plentiful and preferred food source. Thus, fishermen have often used natural fish eggs as bait when salmonid fishing. The means for using natural eggs typically involves using a net or mesh sack to bundle a grouping of the natural eggs and attaching the net or mesh to a hook. Due to the fragile nature of the natural eggs, it is difficult to maintain the eggs' attachment on a hook for any length of time. Further, the necessity of grouping eggs inside sacks or mesh has prevented the eggs from appearing natural, and thus has reduced the effectiveness of this type of bait when fishing.

A significant segment of salmonid fisherman are fly fishermen. Fly fishing requires the use of a highly flexible rod which casts a weighted and/or tapered line which is tipped with a short segment of lightweight leader material. The lure or “fly” is necessarily light in weight and is attached to the end of the leader. Because of the casting motion required, a natural fish egg will generally not remain affixed to a hook and will be literally torn off as the fly line is thrown. Therefore, any egg pattern fly created to date is typically made of a fiber material securely tied to a hook. Artificial eggs constructed of dyed yarn or pompons tied on a hook are also used. Furthermore, many fly fishermen tie or create their own flies.

### SUMMARY OF THE INVENTION

In accordance with the present invention, a fishing lure is provided including at least one simulated fish egg connected to a fish hook, or for connecting to a fish hook, which mimics the visual, olfactory, and textural sensory stimulants of a natural fish egg, thereby increasing a fisherman's ability to hook trout, salmon, and other fish in that family group. In this respect, an improved fishing lure is provided with a body portion and a fish hook associated with the body portion. An absorbent interior portion is provided with an attachment line passing through the interior portion. The body portion comprises a soft plastic resin and the interior portion is impregnated with fish scent attractant. The interior portion and a segment of the attachment line proximal to the interior portion is encapsulated by the body portion. A securing means is provided for attaching the attachment line to the fish hook.

In another aspect of the invention, an improved simulated fish egg for use in fishing lures is provided comprising a plurality of interior portions. The plurality of interior portions are spaced apart from one another and connected by an attachment line. The plurality of interior portions are impregnated with fish scent attractant. Each one of the interior portions and at least one segment of associated attachment line proximal to each of the interior portions are surrounded and encapsulated by a nonporous body portion. The body portion comprises a soft translucent plastic resin and the interior portion comprises a porous material.

In yet another aspect of the invention, an improved method for creating an artificial fishing lure is provided, comprising the steps of providing an attachment line; creating an absorbent portion; attaching the absorbent portion onto an attachment line; impregnating the absorbent portion with a fish attractant; creating a plastic material; forming the plastic material around the absorbent portion and at least one segment of the attachment line into a lure shape; and curing the plastic material into a nonporous body portion surrounding the absorbent portion.

In still a further aspect of the invention, an improved method for using an artificial fishing lure is provided comprising the steps of: providing an attachment line; creating an absorbent portion; attaching the absorbent portion onto the attachment line; impregnating the absorbent portion with a fish attractant; creating aplastic material; forming the plastic material around the absorbent portion and at least one segment of the attachment line into a lure shape; curing the plastic material into a nonporous body portion surrounding the absorbent portion; attaching the attachment line to a fish hook thereby forming the fishing lure; attaching the fish hook to a fishing line; and piercing the body portion thereby forming at least one passage therethrough.

Other benefits and advantages of the subject invention will become apparent to those skilled in the art upon a reading and understanding of the specification.

### BRIEF DESCRIPTION OF THE DRAWINGS

The invention may take physical form in certain parts and steps and arrangements of parts and steps, the preferred embodiments of which will be described in detail in the specification and illustrated in the accompanying drawings which form a part hereof and wherein:

FIG. 1 is a side elevation view of first embodiment including a single simulated fish egg (showing internal parts in phantom);

FIG. 2 is a side elevation view of the first embodiment including five simulated fish eggs also showing internal parts in phantom;

FIG. 3 is a side elevation view of the first embodiment of the fishing lure including a single simulated fish egg on a hook;

FIG. 4 is a side elevation of the first embodiment of the fishing lure including a pair of simulated fish eggs on a hook;

FIG. 5 is a side elevation of the first embodiment of the fishing lure including a pair of simulated fish eggs and hair-like streamers extending therebetween on a hook;

FIG. 6 is a side view of a second embodiment including a plastic strand used during the tying procedure to form an egg or spawn cluster;

FIG. 7 is a side view of a third embodiment including a series of plastic ovoid segments formed onto a thread and used during the tying procedure to form a fish egg or spawn cluster;

FIG. 8 is a side view of a fourth embodiment including a pair of minnow-like plastic shapes used during the tying procedure to form a minnow-like lure;

FIG. 9 is a side elevation of the second embodiment and first embodiment of the fishing lure including loops tightly wrapped around a hook and secured thereto and also including a single simulated fish egg;

FIG. 10 is a side elevation of the second embodiment of the fishing lure including loops wrapped around a hook and secured thereto and hair-like streamers; and,

FIG. 11 is a side elevation view of the third embodiment of the fishing lure including ovoid segments wrapped around a hook and secured thereto.

### DETAILED DESCRIPTION OF PREFERRED EMBODIMENTS

Referring now to the drawings in greater detail, FIGS. 1-5 illustrate a first embodiment of the fishing lure of the present invention. FIG. 1 displays a single simulated fish egg 10. The fish egg 10 includes an absorbent interior portion 12 including a thread or attachment line 14 passing therethrough. The interior portion 12 and segments 14a, 14b of the attachment line 14 (proximal to the absorbent portion) are surrounded by a plastic body portion 16. The interior portion 12 comprises an absorbent, for example, sponge material. The interior portion 12 or core of the lure can be formed of a cellular, sponge material such as natural sponge or plastic sponge such as polyethylene sponge, etc. The body portion 16 comprises, for example, a soft translucent plastic resin. The plastic resin, upon curing, creates a nonporous or hydrophobic material. The body portion 16 can be formed of any suitable nonporous plastic resin material. In a preferred embodiment, the body portion 16 includes nonbuoyant material. Such materials often include fillers, plasticizers, and other components. They are available commercially from many sources. Appropriate materials include polyvinyl chloride in a plastisol form, an example of specific available materials include resins manufactured by The M-F Company. The chemistry required to produce plastisol as used in the manufacture of soft plastic fishing lures is commonly known. It consists primarily of polyvinyl chloride resin dispersed in a plasticizer. This formula produces a soft, pliable plastic lure suitable for the market. Ingredients used in this invention are all commercially available from commonly-known sources.

Prior to encapsulating the absorbent interior portion 12 with the body portion 16, the interior portion 12 is saturated with a fish attractant 18. The interior portion 12 comprises a porous or oleophilic material which has an affinity for the conventional fish attractants that may be used such as cod liver oil, fish meal, blood meal, etc. In the embodiment shown in FIG. 1, the body portion 16 comprises a translucent material and the interior absorbent portion 12 includes an opaque appearance, thereby causing a contrast in colors. It is to be appreciated that the interior portion may employ a variety of differing thicknesses, sizes, or diameters with respect to the body portion. Additionally, pigments may be added to the interior portion and/or the body portion to create contrasting colors, for example, yellow/black, yellow/blue, red/orange, etc. This contrast in colors represents one of the visual characteristics that appeals to fish.

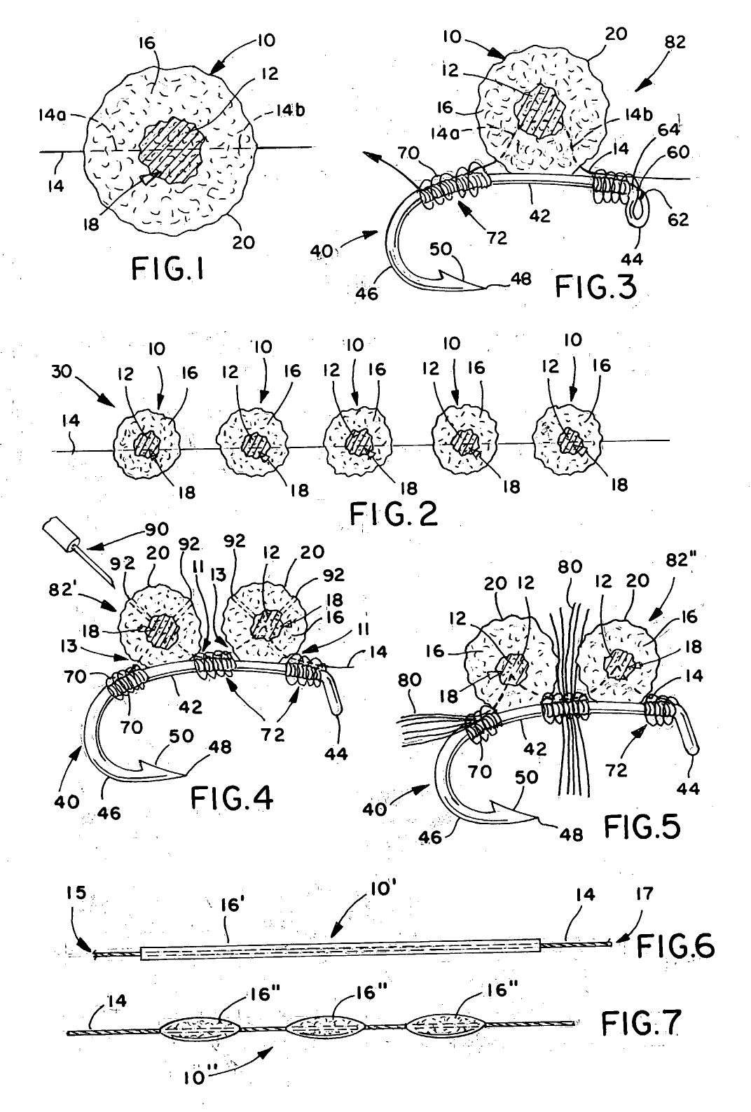

Referring now to FIG. 2, a plurality of simulated fish eggs resembling a chain of beads 30 is shown connected by attachment line 14 passing through the interior portions 12 of each respective simulated egg 10. To produce a single egg 10 or bead chain 30, the liquid plastic must be heated to a melting temperature, i.e. 300°-350° F. The liquid plastic can be colored once the heated plastic reaches a syrupy consistency. One ounce of color per gallon of plastic has proven effective. The heated plastic is to be injected into a series of round molds (not shown). Prior to injection, a series of approximately 1/8-inch round sponge segments 12 are threaded onto a suitable length attachment line 14. The sponges or interior portions 12 are attached to the line 14 at, for example, ½-inch intervals. The sponge material 12 is impregnated with an appropriate fish attractant 18, and the line 14 and sponge material 12 are placed inside the series of mold spaces. Once in place, the heated and colored liquid plastic is injected into the mold to create an egg 10 or bead chain of eggs 30. The plastic resin is formed in an assortment of colors and sizes to replicate the eggs or spawn of different fish species. A user of the bead chain 30 can select one or more of the eggs 10 to attach to a hook, weighted jig head, or other lure. A fly tier can create a customized fly pattern by connecting the line 14 and any number of simulated eggs 10 to a fish hook 40. The bead chain 30 configuration of simulated eggs 10 allows ease of handling while tying the eggs 10 to a fish hook 40. It will be appreciated that any number of eggs 10 can be attached to the fish hook 40 and any remaining eggs 10 may be severed from the tied (attached) group by simply cutting the line 14.

As shown in FIG. 3, a single simulated fish egg 10 is secured by the attachment line 14 to the shank 42 of any fish hook 40 such as a conventional fish hook. Any number of different methods can be used to secure the attachment line 14 to the shank 42. For example, glueing, curing plastic material, shrink wrapping, embedding, thread wrappings, etc. Conventional fish hooks 40 are typically formed of metal including an eye 44 bent at one end for securing a fishing line leading from a rod, such as a fly rod, and a curved portion 46 at the opposite end terminating with a sharpened point 48. Conventional hooks 40 include a barb 50 proximal to the point 48. A gap 60 extends between the end 62 of bent eye 44 and the beginning 64 of shank 42. It will be appreciated that conventional fish hooks 40 come in a variety of sizes and configurations, and may or may not include a barb 50. The simulated fish eggs 10 are secured along the shank 42 portion in various positions depending on the number of eggs 10 to be included (See FIGS. 3 and 4). Additionally, various other materials may be attached to the hook 40 if desired, such as hair-like streamers 80 if desired (see FIG. 5). The simulated fish egg 10 is secured to the shank 42 such that its interior portion 12 is spaced from the shank 42 with the hook 40 suspended there below. Positioning of the simulated fish eggs 10 in this manner provides the appearance of a natural fish egg drifting in the current when placed in the water.

Referring again to FIG. 2, the individual fish eggs 10 are attached by the attachment line 14 that passes through the interior portion 12 of each simulated egg 10. The body portion 16, exterior portion of the simulated egg, is formed around the interior portion 12 and line 14 thereby encapsulating the interior portion 12 therein. The attachment line 14 may be comprised of fly-tying thread in any number of colors. It is to be appreciated that although fly-tying thread is presently preferred, any number of other materials such as thin metal wire, monofilament line, lead, rubber strand, etc. could also be used.

As shown in FIGS. 3-5, the simulated fish eggs 10 and attachment line 14 is secured to the shank 42 of a fish hook 40 by a second continuous attaching line 70 wrapped around the shank 42 from a position proximal to the eye 44 rearwardly along the shank 42 toward the bend 46 in the hook 40. Attaching line 70 is preferably a conventional fly-tying thread. Any number of different configurations can be used for attaching the (attachment) line 14 and fish egg 10 to the hook 40. Typically, a series of loops 72 will be used proximal to a forward edge 11 and a rearward edge 13 of each simulated egg 10. The wrappings may comprise loops 72 formed in a forward and/or rearward direction along the shank 42 of the hook 40 and will involve wrapping line 70 numerous times about shank 42 for securing the attaching line 14 and fish egg 10 to the hook 40. After the attachment line 14 and egg(s) 10 have been secured to the hook 40, the attaching line 70 may be pulled tightly in a “whip finish” knot (not shown) which holds the egg(s) 10 securely on the shank 42. The end of line 14 may then be trimmed close to the attaching line 70. As shown in FIG. 5, a quantity of decorative hair-like streamers 80 or strands may also be secured within the wrappings of the attaching line 70 and extend outward between, for example, a pair of simulated eggs 10. It will be appreciated that any number of fly-tying materials may be attached to the shank 42 of a hook 40 interspersed along and between the fish eggs 10. These other materials may include, but are not limited to, the following: yarn, deer hair, hackles, tinsel, lead, feathers, etc.

At this point, fishing lures 82, 82′, 82″ (FIGS. 3, 4, and 5, respectively) are in a completed arrangement and may be placed in a fishing tackle box or fly box. It will be appreciated that the absorbent interior portion 12 being encapsulated by the body portion 16 prevents the fish attractant 18 from diffusing to the outside surface 20 of the body portion 16 and depleting its fish attractant 18. It will also be appreciated that by preventing the diffusion of the fish attractant 18, other flies and tackle within the fly box are not contaminated. The fish attractant 18 remains encased until time of use, thus preserving attractant 18 and eliminating the need to carry additional attractant and reimpregnate the interior portion 12. When a fisherman desires to use the lure, the lure is tied to the end of a fishing line. If the fish attractant 18 is desired, then prior to casting the lure, a needle 90 (or hook eye cleaner) is used for piercing or puncturing the body portion 16 from its outer surface 20 to the interior portion 12 (FIG. 4). The piercing provides for a passageway 92 which allows the fish attractant 18 to dispense to the exterior surface 20 of the body portion 16 and into the surrounding water. It will be appreciated that any number of piercings may be performed dependent upon the fisherman's preference and/or fishing conditions. More piercings will accelerate the amount of fish attractant 18 being dispensed to the surrounding water. The fisherman may also compress the pierced simulated egg 10 to force fish attractant through the passageways 92.

Fish initially detect food by a variety of sensory mechanisms, primarily vision and olfaction. The aforementioned simulated egg 10 appeals to both of these sensory mechanisms. However, taste generally also plays a key role in determining whether a potential food item is swallowed or immediately rejected. The taste system of salmonids appears to be well-tuned for the detection and ingestion of food. The lure 82′ dispenses the fish attractant 18 during drifting or pulling of the lure 82′ through a body of water. By virtue of the resilient nature of the body portion 16, a force generated by a fish bite will compress the body portion 16 and the interior portion 12 thereby forcing the fish attractant 18 through the passageways 92 and out of the eggs 10. This dispensing of the fish attractant 18 in response to the fish bite serves to further convince the fish that the lure 82′ is a natural egg. Appealing to a salmonid's sense of taste greatly improves an angler's ability to hook a fish.

FIG. 6 displays a second embodiment of the invention. Namely, a continuous coated segment 10′ is formed of plastic surrounding an appropriate length of attachment line 14. Bare line segments 15, 17 of line 14 will extend a distance beyond each end of the continuous coated segment 10′. The continuous coated segment 10′ includes an elongated body portion 16′. The continuous coated segment 10′ is capable of being wrapped around and tied directly onto a hook 40 (see FIGS. 9 and 10). The segment 10′ after winding and tying onto the hook 40 forms a soft segmented tubular body about the shank 42. The segment 10′ can be further secured by using fly-tying thread 70 as described above. The fishing lure of FIG. 9 also incorporates a single simulated egg 10.

Similarly, FIG. 7 displays another embodiment 10″ in which a plurality of plastic ovoid body portions 16″, for example, 1/4 inch in length, are formed onto a suitable length attachment line 14 and separated from one another at a distance of, for example, 1/8 inch. As seen in FIG. 11, the plurality 10″ of ovoid body portions 16″ are formed into small loops and the attachment line 14 may then be tied onto the fish hook 40 about the shank 42. As shown in FIG. 11, the plurality 10″ of ovoid body portions 16″ may be tied in a cluster or loop arrangement, to replicate a plurality of fish eggs or spawn cluster.

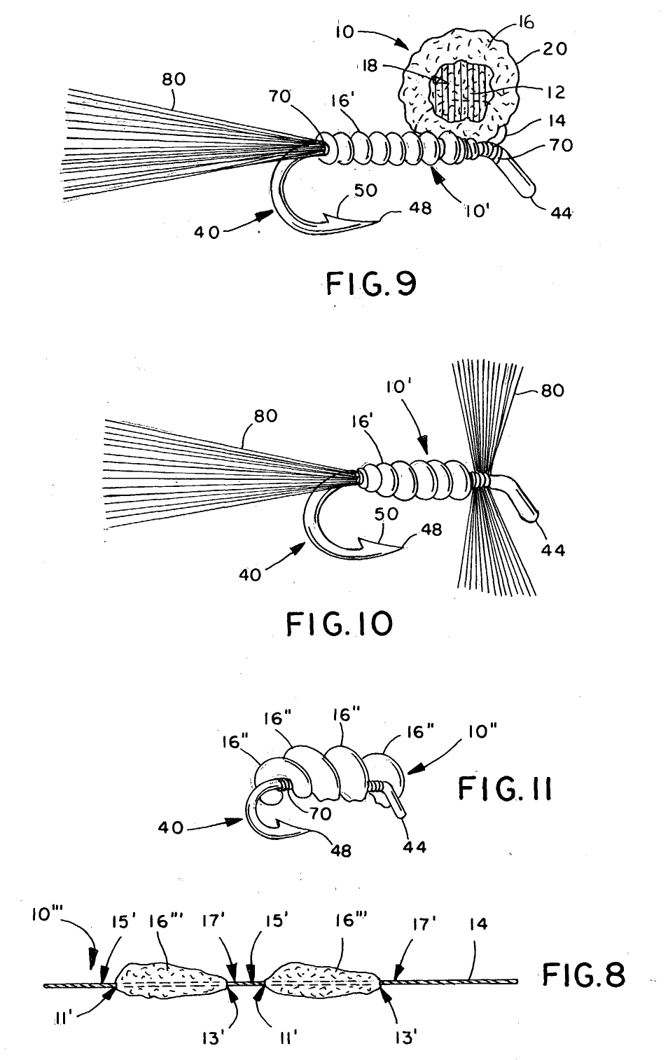

FIG. 8 displays another embodiment 10′″ of the invention wherein the plastic material is formed into minnow-like body portions 16′″ around attachment line 14. The minnow-like body portions 16′″ may be individually secured (not shown) to a fish hook such that the minnow-like body portion 16′″ extends along, above, or below the shank. In this manner, portions of attachment line 15′, 17′ extending beyond respective ends 11′, 13′ of the body portion 16′″ are secured to the shank thereby holding body portion 16′″ proximal to the shank. It is appreciated that body portion 16′″, in this secured position, has some limited movement with respect to the hook thereby resulting in a more natural appearing fishing lure when pulled through the water. Although not shown, it is to be appreciated that the body portions 16′, 16″, and 16′″ may also include an encapsulated absorbent interior portion and/or an impregnated odorant.

While particular embodiments have been described, alternatives, modifications, variations, improvements, and substantial equivalents that are or may be presently unforeseen may arise to applicants or others skilled in the art. Accordingly, the appended claims as filed, and as they may be amended, are intended to embrace all such alternatives, modifications, variations, improvements, and substantial equivalents.

1-23. (canceled)

24. A method of making an artificial fishing lure comprising the steps of:
(a) providing an attachment line;
(b) creating an absorbent portion;
(c) attaching said absorbent portion onto an attachment line;
(d) impregnating said absorbent portion with a fish attractant;
(e) melting a plastic material;
(f) forming said plastic material around said absorbent portion and at least one segment of said attachment line into a lure shape; and
(g) curing said plastic material into a nonporous body portion surrounding said absorbent portion.

25. The method of claim 24, further comprising the step of (h) attaching said lure shape to a fish hook.

26. The method of claim 25, wherein said lure shape comprises a fish egg imitating shape.

27. The method of claim 24, wherein said plastic material encapsulates said absorbent portion.

28. The method of claim 27, further comprising the step (h) of piercing said plastic material, thereby forming a passageway from the exterior surface of said plastic material to said absorbent portion.

29. The method of claim 28, wherein said fish attractant secretes through said passageway.

30-31. (canceled).

32. A method of making an artificial fishing lure comprising the steps of:
(a) providing an attachment line;
(b) melting a plastic material;
(c) forming said plastic material around at least one segment of said attachment line into a lure shape;
(d) curing said plastic material into a non-porous body portion; and,
(e) affixing said non-porous body portion to said at least one segment of said attachment line whereby said body portion is secured around said at least one segment of said attachment line.

33. The method of claim 32, further comprising the step of (f) attaching said lure shape to a shank of a fish hook.

34. The method of claim 33, wherein said lure shape comprises an elongate tubular shape.

35. The method of claim 33, wherein said lure shape comprises an ovoid shape.

36. The method of claim 33, wherein said lure shape comprises a minnow-like shape.

37. A method of making an artificial fishing lure comprising the steps of:
(a) providing an attachment line;
(b) melting a plastic material;
(c) forming said plastic material around at least one segment of said attachment line into a lure shape;
(d) curing said plastic material into a non-porous body portion; and,
(e) attaching said lure shape to a shank of a fish hook.

38. A method of making an artificial fly-tying material comprising the steps of:
(a) providing an attachment line;
(b) melting a plastic material;
(c) forming said plastic material around at least one segment of said attachment line into at least one shape; and,
(d) curing said plastic material into a non-porous body portion whereby said body portion is secured around said at least one segment of said attachment line.
